(19) United States
(12) Patent Application Publication
(10) Pub. No.: US 2024/0401866 A1
(43) Pub. Date: Dec. 5, 2024

(54) METHOD AND APPARATUS FOR SUPERCOOLING PERISHABLES

(71) Applicant: EverCase, Inc., Wimberley, TX (US)

(72) Inventors: Christopher Phillippe Somogyi, Wimberly, TX (US); Jochen Philipp Backs, Mill Valley, CA (US); Mark Samuel Freeman, Redmond, WA (US); Allan Stephan, Seattle, WA (US); Maxwell Jeffrey Borchers, Berkley, MI (US); Rosa Mach Batlle, Barcelona (ES); Paul Vernon Budak, Marysville, WA (US)

(21) Appl. No.: 18/494,568

(22) Filed: Oct. 25, 2023

Related U.S. Application Data
(60) Provisional application No. 63/506,289, filed on Jun. 5, 2023.

(51) Int. Cl. F25D 21/04; F25D 11/04

(52) U.S. Cl. CPC F25D 21/04; F25D 11/04

(57) ABSTRACT

Perishable products, such as food items or biological samples, often require specific temperature control to prolong their shelf life or maintain their integrity during storage and transportation. Supercooling, achieved by subjecting the products to pulsed electric fields, can effectively reduce their temperature while preserving their quality. The present disclosure addresses the various drawbacks in the related art by providing a method and system for selectively applying pulsed electric fields to perishable products using a plurality of electrodes. The method includes supplying power to different combinations of electrodes positioned within a container housing the perishable products, obtaining measurement data for each combination, selecting the combination based on the obtained measurement data, and applying a pulsed electric field between the selected electrodes to cool the perishable products.

### BACKGROUND

### Technical Field

This present disclosure relates generally to the field of preserving perishable materials, such as food or biological tissues. More specifically, it concerns innovative methods and apparatus for the preservation of food that maintain the freshness of products while stored at temperatures below the freezing point. Additionally, the present disclosure has potential applications in the storage and preservation of other types of perishable materials, including biological products such as organs and tissues.

### Description of the Related Art

Preservation and storage of perishable goods, particularly food and biological tissues, are pivotal in both everyday life and numerous industry sectors. Further, the preservation of perishable goods, particularly food, is a critical aspect of ensuring public health and safety. Among the various methods employed for this purpose, chilling or freezing food items is considered an effective way to slow decomposition and inhibit the growth of harmful microorganisms. Freezing offers a particularly potent method of preserving food safety and quality over extended storage periods.

Despite its effectiveness, the freezing and subsequent thawing process is known to present substantial challenges regarding food quality. One major issue lies in the formation and growth of ice crystals during freezing. Ice crystallization can cause irreversible damage to the tissue structures of various food items, such as meats, fish, fruits, and vegetables. This damage may manifest as structural ruptures and changes in osmotic pressure, which can detrimentally affect the quality and sensory properties of the food product, including color, taste, and perceived freshness.

Additionally, if a food product is subjected to extended periods of freezing, it may experience lipid oxidation, protein denaturation, ice recrystallization, and changes in moisture content. The degradation of food product quality is directly linked to the structural damages inflicted by the formation, growth, and distribution of ice crystals within the food. These freezing-associated problems underscore the significance of effectively controlling ice crystal formation and growth during food storage.

### BRIEF SUMMARY

Various embodiments of the present disclosure provide a method for preserving and storing perishable materials, with a specific focus on the innovative application of electric fields for enhancing the quality and prolonging the shelf-life of stored items. This is achieved by way of reusable or disposable containers equipped with an array of at least two electrodes that permit the strategic application of electric fields to the contained perishable goods.

Various embodiments of the present disclosure address the shortcomings of the conventional methods and introduces an advanced system of containers designed for the application of electric fields to perishable goods. These containers can come in various configurations, as discussed further herein.

Various embodiments of the present disclosure provide the technical benefits of avoiding structural damage to food products (which was inevitable according to the conventional freezing method due to ice crystal formation during the freezing and subsequent thawing phases); extending the shelf-life of stored perishable products; preserving and maintaining the freshness and quality of the perishable products; and maintaining the integrity of the perishable products during storage and transportation.

An example embodiment of the present disclosure includes a method. The method includes for each combination of a plurality of combinations of electrodes: supplying power to the combination of the electrodes. Here, the electrodes are positioned within a container that houses one or more perishable products. The method includes obtaining measurement data for the combination of the electrodes. The method includes selecting a combination of the electrodes from the plurality of combinations of the electrodes based on the obtained measurement data. The method includes applying a pulsed electric field between a first electrode and a second electrode of the selected combination of the electrodes so as to apply the pulsed electric field to the one or more perishable products that contact the first electrode and the second electrode. Here, the measurement data includes an impedance value of the one or more perishable products.

The method includes maintaining a temperature of the one or more perishable products within a selected temperature range while the pulsed electric field is applied between the first electrode and the second electrode of the selected combination of the electrodes.

The method includes applying an oscillating magnetic field to the one or more perishable products in the container while concurrently applying the pulsed electric field to the one or more perishable products.

The step of selecting a combination of the electrodes based on the obtained measurement data includes selecting a pair of electrodes that outputs the highest impedance value of the one or more perishable products. In one embodiment, the selected pair of electrodes that outputs the highest impedance value is the first electrode and the second electrode.

The step of supplying power to a combination of electrodes positioned within a container configured to house one or more perishable products includes: determining whether there is an overlap between electrodes and the one or more perishable products; and selecting a combination of electrodes among electrodes that overlap with the one or more perishable product.

The step of obtaining measurement data for the combination of the electrodes includes obtaining measurement data between electrodes that are positioned the greatest distance from each other among the electrodes that overlap with the one or more perishable products; and obtaining measurement data between electrodes that are positioned the second greatest distance from each other among the electrodes that overlap with the one or more perishable products.

In one embodiment, among the combination of the electrodes, electrodes that are nearest each other are measured last.

An example embodiment of the present disclosure includes another method. The method includes providing a perishable product in a container having a plurality of electrodes spaced apart from each other. The perishable product contacts at least two electrodes of the plurality. The method includes supplying power to the plurality of electrodes. The method includes obtaining impedance values based on respective combinations of the electrodes of the plurality. The method includes selecting a pair of electrodes that contacts the perishable product and has the highest impedance value. The method includes applying a pulsed electric field to the perishable product by supplying power between the selected pair of electrodes.

The step of supplying power to the plurality of electrodes includes determining whether there is contact between electrodes of the plurality and the perishable product; and supplying power to the electrodes that are in contact with the perishable product.

The step of obtaining impedance values based on respective combinations of the electrodes includes obtaining an impedance value between electrodes that are positioned the greatest distance from each other among the electrodes that contact with the perishable product; and obtaining measurement data between electrodes that are positioned the second greatest distance from each other among the electrodes that are in contact with the perishable product.

An example embodiment of the present disclosure includes a supercooling container. The supercooling container includes a bottom surface, one or more side surfaces connected to the bottom surface, and a plurality of electrodes located in various locations within the supercooling container. A selected pair of electrodes of the plurality is configured to pass current through a perishable product contacting the selected pair of electrodes. Here, each of the plurality of electrodes is spaced apart from each other.

In one embodiment, each of the plurality of electrodes is disposed only on the bottom surface.

In one embodiment, at least one of the plurality of electrodes is disposed at the bottom surface, and at least one of the plurality of electrodes is disposed on at least one of the side surfaces.

In one embodiment, each of the plurality of electrodes has a circular shape or a polygonal shape.

In one embodiment, the supercooling container includes a top surface connected to the one or more side surfaces. In this embodiment, at least one electrode of the plurality of electrodes is disposed on the top surface, and at least one electrode of the plurality of electrodes is disposed on the bottom surface.

An example embodiment of the present disclosure includes a system. The system may include a refrigeration system such as the conventional refrigerator. They system includes a supercooling container that includes a bottom surface, side surfaces connected to the bottom surface, and a plurality of electrodes located in various locations within the supercooling container.

The system includes a pulsed electric field generator operatively coupled to the plurality of electrodes of the supercooling container. The pulsed electric field generator, in operation, applies a pulsed electric field to the plurality of electrodes to pass current through one or more perishable products.

The system includes a temperature controller operatively coupled to the supercooling container, the temperature controller, in operation, controls a temperature of the one or more perishable products in the supercooling container to a selected temperature range.

The system includes a controller operatively coupled to the supercooling container. The controller, in operation, for each combination of a plurality of combinations of electrodes, supplies power to the combination of the electrodes.

The controller obtains measurement data for the combination of the electrodes. The controller selects a combination of the electrodes from the plurality of combinations of the electrodes based on the obtained measurement data. The controller causes to apply the pulsed electric field between a first electrode and a second electrode of the selected combination of the electrodes so as to apply the pulsed electric field to the one or more perishable products that contact the first electrode and the second electrode.

The temperature controller, in operation, maintains a temperature of the one or more perishable products within a selected temperature range while the pulsed electric field is applied between the first electrode and the second electrode of the selected combination of the electrodes.

The step of selecting a combination of the electrodes based on the obtained measurement data includes selecting a pair of electrodes that outputs the highest impedance value of the one or more perishable products. Here, the selected pair of electrodes that outputs the highest impedance value is the first electrode and the second electrode.

The step of supplying power to a combination of electrodes includes determining whether there is an overlap between electrodes and the one or more perishable products; and selecting a combination of electrodes among electrodes that overlap with the one or more perishable products.

The step of obtaining measurement data for the combination of the electrodes includes obtaining measurement data between electrodes that are positioned the greatest distance from each other among the electrodes that overlap with the one or more perishable products; and obtaining measurement data between electrodes that are positioned the second greatest distance from each other among the electrodes that overlap with the one or more perishable products.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless the context indicates otherwise. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Moreover, some elements known to those of skill in the art have not been illustrated in the drawings for ease of illustration. One or more embodiments are described hereinafter with reference to the accompanying drawings in which:

FIG. 1 shows an example system a supercooling container can be incorporated into according to some embodiments of the present disclosure;

FIG. 2A is a perspective view of a supercooling container according to some embodiments of the present disclosure;

FIG. 2B is a top view of a supercooling container shown in FIG. 2A;

FIG. 2C is a bottom view of a supercooling container shown in FIG. 2A;

FIG. 2D is a side view of a supercooling container that includes electrodes with different heights according to some embodiments of the present disclosure;

FIG. 2E is a top view of a supercooling container including electrodes having a circular shape according to another embodiment of the present disclosure;

FIG. 2F is a top view of a supercooling container including electrodes having a bar shape according to another embodiment of the present disclosure;

FIG. 2G is a top view of a supercooling container including electrodes having various curly coil shape according to another embodiment of the present disclosure;

FIG. 2H illustrates a supercooling container including electrodes having a cylindrical shape with varying heights according to another embodiment of the present disclosure;

FIG. 2I is a side view showing cylindrical shaped electrodes with varying heights at the bottom of a supercooling container as shown in FIG. 2H;

FIG. 2J is a view showing cylindrical shaped electrodes can have adjusted heights by controlling the height of the electrode at the bottom of a supercooling container;

FIG. 3 is a view showing the electrical connections of a power supply source, a controller, and a supercooling container;

FIG. 4 is a flow chart of an example method according to some embodiments of the present disclosure;

FIG. 5 illustrates a stepwise control of pulsed electric field and oscillating magnetic field during supercooling;

FIG. 6 is an example system diagram of a supercooling system including the supercooling apparatus shown in FIG. 1;

FIG. 7A is a perspective view of an example electrode having a plurality of pores according to some embodiments of the present disclosure; and

FIG. 7B is a bottom perspective view of the electrode having a plurality of pores as shown in FIG. 7A.

### DETAILED DESCRIPTION

The following description, along with the accompanying drawings, sets forth certain specific details to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the interfaces, power supplies, physical component layout, communication systems and networks and the environment, have not been shown or described in order to avoid unnecessarily obscuring descriptions of the embodiments. Additionally, the various embodiments may be methods, systems, or devices.

Accordingly, the various embodiments may combine software and hardware aspects. Throughout the specification, claims, and drawings, the following terms take the following meanings, unless the context indicates otherwise. The term “herein” refers to the specification, claims, and drawings associated with the current application. The phrases “in one embodiment,” “in another embodiment.” “in various embodiments.” “in some embodiments,” “in other embodiments,” and other variations thereof refer to one or more features, structures, functions, limitations, or characteristics of the present disclosure, and are not limited to the same or different embodiments unless the context indicates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context indicates otherwise. In addition, throughout the specification, the meaning of “a,” “an,” and “the” include singular and plural references.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

The present disclosure relates to a method, apparatus, and system for applying pulsed electric fields to perishable products, particularly for supercooling purposes. Various embodiments of the present disclosure provide a method, apparatus, and system for selectively applying pulsed electric fields to perishable products within a container (e.g., supercooling container) using a plurality of electrodes.

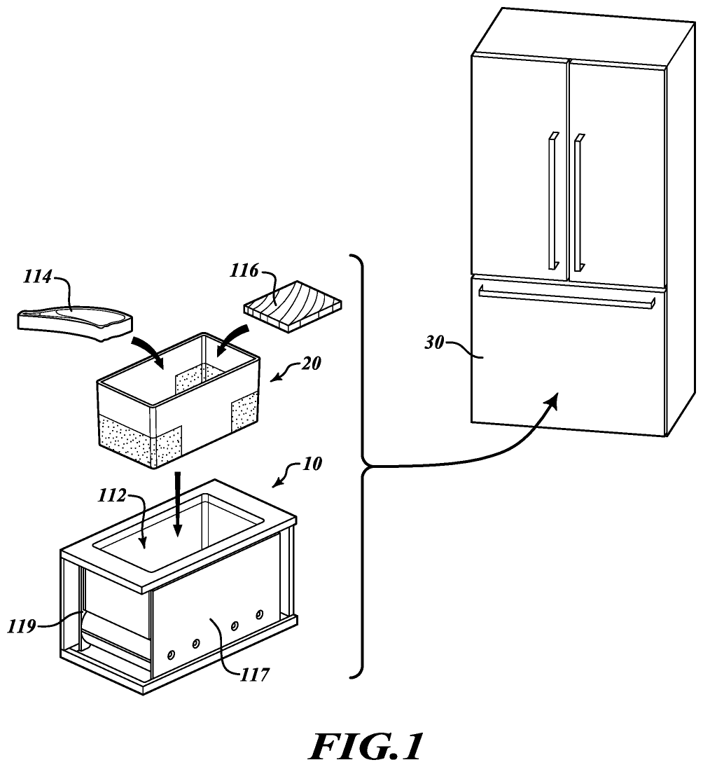

FIG. 1 shows an example system a supercooling container can be incorporated into according to some embodiments of the present disclosure.

Supercooling or the supercooling process can be defined as the process of cooling the temperature of a perishable product below its freezing temperature without ice crystal formation. The supercooling function according to the present disclosure may be accomplished by using at least one of magnetic field, electric field, displacement current, or a combination thereof. The perishable product can be said to be in a supercooling state when the perishable product is below its freezing temperature without ice crystal formation. According to some embodiments, at least one of a magnetic field, electric field, or displacement current is applied to the perishable product in order to achieve the supercooling functionality.

The term “perishable product” is used broadly herein to include any type of perishable materials and substances. A typical example may include food products. The food products may include, but are not limited to, meat products (e.g., beef, pork, or the like), seafood products (e.g., shellfish, fish, crustaceans, mollusks, or the like), poultry products (e.g., chicken), vegetables, fruits (pineapples, berries, stone fruit, etc.), dairy products, prepared meals, etc. The perishable products also include biological products, including organs, tissues, biologics, cell cultures, stem cells, embryos, blood (e.g., whole blood, red blood cells, platelets, plasma, or the like), reactive solutions, vaccines, sperm, unstable chemical reagents, flowers, or any item requiring cooled storage.

As illustrated, a supercooling apparatus 10 (hereinafter “apparatus”) includes a supercooling container 20 (hereinafter also referred to as “a container”). The supercooling apparatus 10 may include a power supply source (or simply “power source”) within or may be operatively coupled to a power source. The supercooling apparatus 10 is configured to apply an electric field (particularly, a pulsed electric field) to a perishable product (or perishable products) placed within the container 20. The electrodes placed within the container 20 contact the perishable product and power is provided to the electrodes by the power source. Through the contacts made with the electrodes, displacement currents are passed through the perishable product which keeps the perishable product in a supercooling state. In some embodiments, the power source can be a DC power source. In other embodiments, the power source can be an AC power source.

In some embodiments, the supercooling apparatus 10 may also be configured to apply a magnetic field. In these embodiments, the supercooling apparatus 10 includes a first electromagnet 117 and a second electromagnet 119 for applying oscillating magnetic fields to the perishable products. However, applying oscillating magnetic fields can be optional depending on the type of perishable product and depending on the various, different embodiments.

The configuration shown in FIG. 1 is merely an example and other structures and arrangements can be used to apply electric fields or oscillating magnetic fields or both to the perishable products. For example, a solenoid configuration, may be used to apply oscillating magnetic fields within the container 20. In one embodiment, supercooling apparatus 10 can be implemented as a solenoid so that the magnetic field within the container 20 is uniform. For example, any suitable solenoid configuration or segmented solenoids arranged in multiple coil Helmholtz row can be utilized. This arrangement and configuration allow the magnetic field to be swept across the length of the path perpendicular to the windings of the solenoid.

The apparatus 10 according to the present disclosure provides the supercooling functionality for a wide range of different types of perishable products.

Based on the type of perishable product, only a pulsed electric field may be applied to achieve the supercooling functionality. Based on the type of perishable product, only an oscillating magnetic field may be applied to achieve the supercooling functionality. Based on yet another type of perishable product, a combination of a pulsed electric field, oscillating magnetic field, or displacement current may be applied to achieve the supercooling functionality. The pulsed electric fields as used herein refer to electric fields generated based on contacting electrodes. Displacement current is one form of the electric field current. In one or more embodiments, at least one of a magnetic field, electric field, displacement current or certain combinations thereof may be used based on the type of perishable product inside the apparatus 10.

As shown in FIG. 1, the supercooling apparatus 10 can be incorporated into a system 30. The system 30, for example, can be a refrigeration system. An example of a refrigeration system may be a conventional refrigerator or a freezer. In some embodiments, the power source can be supplied from the refrigeration system and therefore, the power source may not be included in the supercooling apparatus 10. In some embodiments, the pulsed electric field and the power source can be provided by the refrigeration system, and therefore only the supercooling container 20 can be placed within the space of the refrigeration system. To elaborate, only the supercooling container 20 including the electrodes can be placed within the system 30 (e.g., refrigeration system). Here, the system 30 can include the power source for providing power to the electrodes. The system 30 can also include other components for supplying at least one of a magnetic field, electric field, displacement current or certain combinations thereof to the perishable product placed within the supercooling container 20.

In operation, the apparatus 10 is provided within a conventional refrigerator or freezer in order to control a temperature of the perishable product in the apparatus to a selected temperature range. The selected temperature range may be between 0° Celsius and −80° Celsius depending on the perishable product.

In FIG. 1, two different types of perishable products are illustrated, a meat 114 and a fish fillet 116. According to one or more embodiments, the apparatus 10 can concurrently supercool different types of perishable products that are placed within the apparatus 10 by applying a magnetic field, electric field, or displacement current that is generated according to specific signal parameters (or hereinafter simply “parameters”) based on the types of the perishable products inside the apparatus.

For instance, each magnetic field, electric field, or displacement current may be associated with parameters such as, but not limited to, strength (e.g., magnetic flux density), amplitudes, power level, type of waveforms (e.g., sine wave, square wave, exponential decay, or jagged, or stair stepped, etc.), frequencies, carrier frequency, vector, duty cycles, phase information, etc. The combination of applying at least one of magnetic fields, electric fields, or displacement current drives the electronics which prevent, for example, water molecules from acting as an ice nucleation site inside the perishable product. That is, the external electric field and magnetic field affects the onset of ice crystal formation during freezing and supercooling processes because water consists of dipole molecules and is also diamagnetic. Accordingly, the water molecules that are naturally present in the perishable product tend to realign and re-orientate under electric and magnetic fields, which makes it possible to prevent the ice crystallization process by applying the appropriate pulsed electric field and oscillating magnetic field.

In one or more embodiments, different combinations of the parameters may be set and applied to at least one of magnetic fields, electric fields, or displacement current to perform the supercooling function to the different types of perishable products. Various different combinations of the parameters may be used for different types of perishable products. In one embodiment, the parameters may be determined based on the use of dielectric spectroscopy which measures the dielectric properties of a medium as a function of frequency. A frequency response of various types of food products can also be used to determine the parameters of the magnetic fields, electric fields, and displacement current.

In one embodiment, the various types of food products such as chicken breast or tuna can be modeled as a resistor. In other embodiments, the various types of food products can be modeled as a medium having dielectric properties. The appropriate parameters to apply for different types of food products can be determined based on interrogating the food product by sending various input signals and sensing the output signals obtained at the other end of the food product using sensors.

As previously described, for some applications, magnetic fields need not be applied to achieve the supercooling function.

In some of the following embodiments of the supercooling container 20 including electrodes therein achieve the supercooling function without the use of magnetic fields. However, applying magnetic fields concurrently with the pulsed electric fields can also achieve the intended supercooling function.

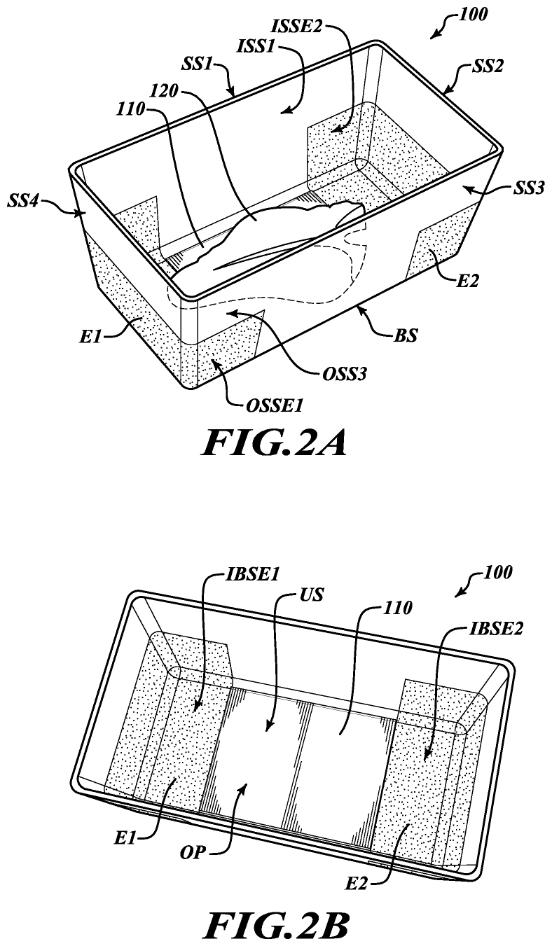

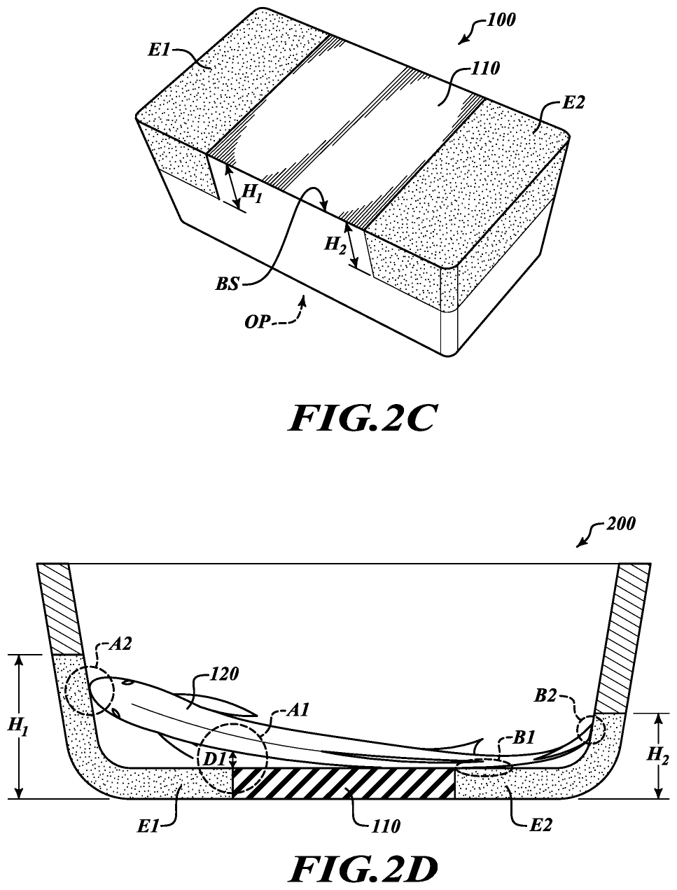

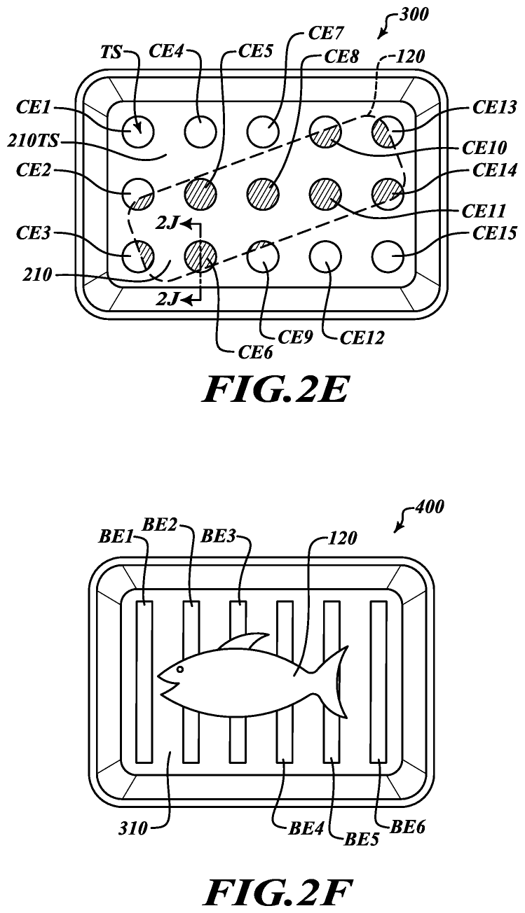

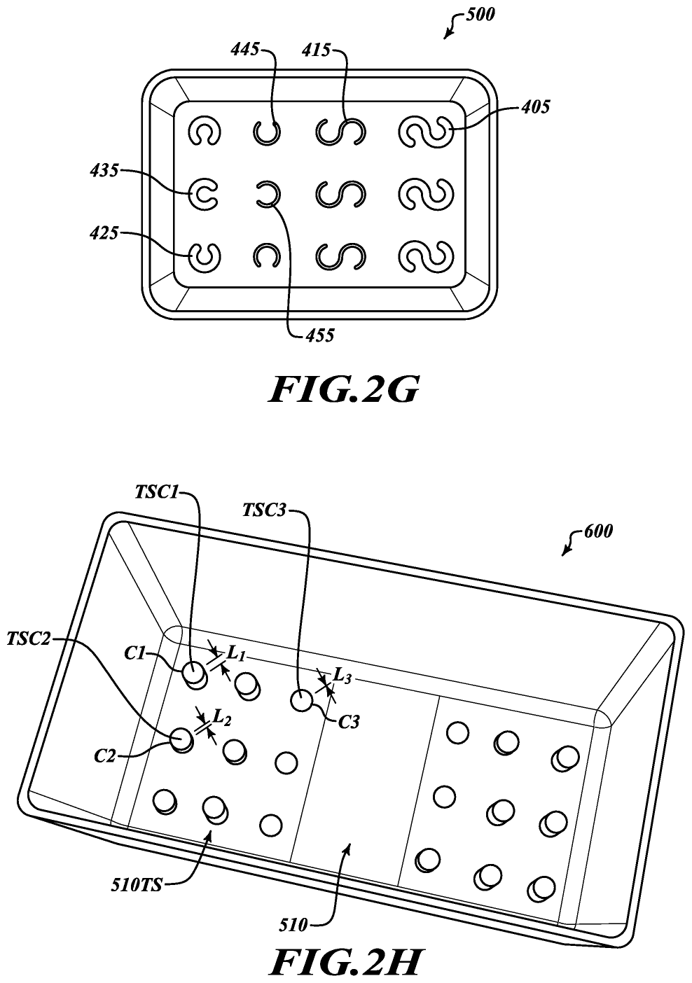

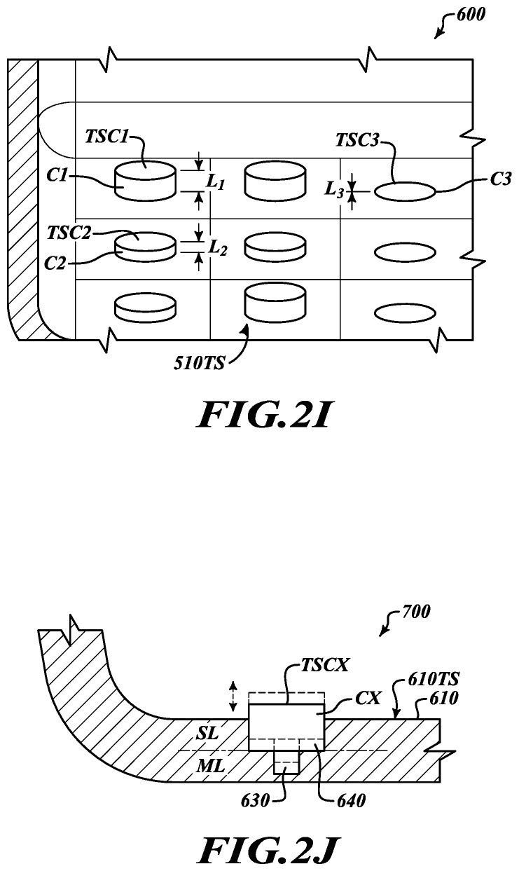

FIG. 2A is a perspective view of a supercooling container according to some embodiments of the present disclosure.

The supercooling container illustrated in FIGS. 2A, 2D, 2E, 2F, 2G, 2H, 2I, and 2J are all different embodiments of the supercooling container 20. Different reference numbers were assigned to different embodiments of the supercooling container which will be detailed below.

FIG. 2A shows a supercooling container 100 having a bottom surface BS, and four side surfaces (e.g., a first side surface SS1, a second side surface SS2, a third side surface SS3, and a fourth side surface SS4) connected to the bottom surface BS. The container 100 includes a first electrode E1 and a second electrode E2 opposite of the first electrode E1. The first electrode E1 and the second electrode E2 are spaced apart from each other by an insulation member 110 that is located on the bottom surface BS of the container 100. The insulation member 110 electrically isolates the first electrode E1 from the second electrode E2. A perishable product 120 is placed within the container 100 to contact the insulation member 110 as well as the first and second electrodes E1, E2. A meat is illustrated as one example of a perishable product 120 and the meat is placed in a way such that one end of the meat contacts the first electrode E1 and the other end of the meat contacts the second electrode E2. This allows the pulsed electric field to be applied to the perishable product 120, namely the meat, by supplying power between the pair of electrodes (e.g., the first and second electrodes E1, E2). The insulation member 110 can be any type of non-conductive material or any material that has substantially low conductivity such as plastic, glass, or the like.

The electrodes within the container 100 can have various shapes, dimensions (e.g., length, width, height, thickness, radius, diameter, area, etc.), and sizes. FIG. 2A shows the electrodes E1. E2 disposed such that they at least partially overlap with the bottom surface and the side surfaces. Here, the first electrode E1 is on and contacts the first side surface SS1, the third side surface SS3, the fourth side surface SS4, and the bottom surface BS. Similarly, the second electrode E2 is on and contacts the first side surface SS1, the second side surface SS2, the third side surface SS3, and the bottom surface BS. In one embodiment, the electrodes can be any type of conductors. A few non-limiting examples include a metal, a conductive Poly (lactic acid) fiber (or conductive PLA fiber), or the like.

In some embodiments, the electrodes are incorporated into the container 100 rather than being coupled to the container 100. For instance, the electrodes may be incorporated into the container 100 such that the bottom surface BS is coplanar with a bottom surface of the first electrode E1 and the second electrode E2. Similarly, an inner side surface of the first side surface SS1, referred to as ISS1 in FIG. 2A is coplanar with an inner side surface of the second electrode E2, referred to as ISSE2 in FIG. 2A. Further, an outer side surface of the third side surface SS3, referred to as OSS3 in FIG. 2A is coplanar with an outer side surface of the first electrode E1, referred to as OSSE1 in FIG. 2A.

In at least some embodiments, the electrodes are made from a nonmagnetic material.

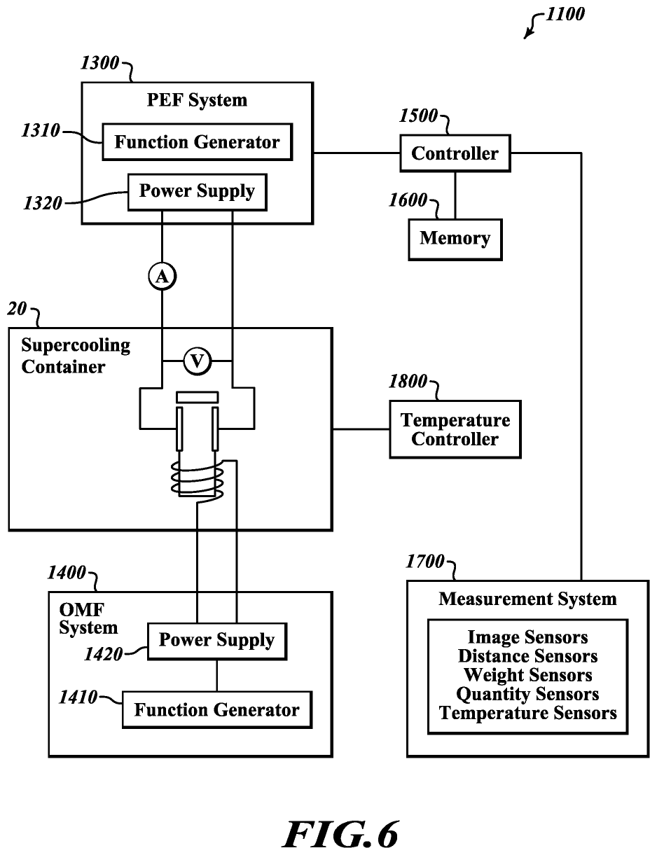

In at least some implementations, the electrodes are positioned such that the electric field generated between them by a power source are orthogonal to magnetic field lines generated by a magnetic field generator (e.g., 1410 in FIG. 6). Furthermore, the electrodes can be on opposite sides of the perishable product, allowing for current to flow through substantially the entire perishable product.

FIG. 2B is a top view of a supercooling container shown in FIG. 2A. In order to better show the bottom of the container 100, the perishable product 120 from FIG. 2A has been omitted in FIG. 2B.

In the top view shown, the insulation member 110 is positioned between the first and second electrodes E1, E2.

In some embodiments, the insulation member 110 may be disposed on and coupled to the bottom surface BS of the container 100.

In other embodiments, the insulation member 110 may be incorporated into the container 100 rather than being coupled to the container 100. That is, the insulation member 110 may be incorporated into the container 100 such that the bottom surface BS is coplanar with a bottom surface of the insulation member 110. Similarly, an upper surface or top surface of the insulation member 110, referred to as US in FIG. 2B is coplanar with an inner bottom surface of the second electrode E2, referred to as IBSE2 in FIG. 2B. Also, the upper surface US of the insulation member 110 is coplanar with an inner bottom surface of the first electrode E1, referred to as IBSE1 in FIG. 2B.

In these embodiments, the upper surface US of the insulation member 110, the inner bottom surface IBSE2 of the second electrode E2, and the inner bottom surface IBSE1 of the first electrode E1 are contiguous and continuous to each other to provide smooth coplanar surface at the bottom of the container 100.

The container 100 further includes an opening OP such that perishable products 120 can be easily placed within and taken out of the container 100. The opening OP of the container 100 does not necessarily have to be sealed or shut in order for the pulsed electric field to be applied. In particular, the first and second electrodes E1, E2 are operatively coupled to or electrically connected to a power source that is configured to supply a pulsed electric field. The pulsed electric field between the first electrode E1 and the second electrode E2 may be applied as long as the perishable product directly or indirectly contacts the first electrode E1 and the second electrode E2. While the pulsed electric field passes through the perishable product 120 more efficiently when the perishable product 120 directly contacts the first electrode E1 and the second electrode E2, even if the perishable product 120 is slightly spaced apart from either the first electrode E1 or the second electrode E2, the pulse electric field may be applied to the perishable product 120 and achieve the intended function and purpose of the supercooling container 100.

However, although not shown in FIG. 2B, the location of the electrodes does not need to be limited to the bottom of the container 100. In some embodiments, the container 100 can have a cover that can be attached and detached when placing perishable product 120 within the container 100 and the bottom of the cover can have electrodes to ensure contact with the perishable product 120.

FIG. 2C is a bottom view of a supercooling container shown in FIG. 2A.

As shown, a first electrode E1 may have a height H1 that extends towards a direction of an opening OP of a container 100. Similarly, a second electrode E2 may have a height H2 that extends towards a direction of the opening OP of the container 100.

In some embodiments, the height H1 of the first electrode E1 and the height H2 of the second electrode E2 may be identical to each other.

However, in other embodiments, the height H1 of the first electrode E1 and the height H2 of the second electrode E2 do not necessarily have to be identical to each other and height H1 may be different from height H2.

The height H1 of the first electrode E1 and the height H2 of the second electrode E2 may be designed to have different heights such that it can accommodate various types of perishable products 120 that have different sizes, shapes, curvature, length, and thickness. This ensures that the perishable product 120 placed within the container 100 contacts the electrodes E1, E2.

FIG. 2D is a side view of a supercooling container that includes electrodes with different heights according to some embodiments of the present disclosure.

In FIG. 2D, a perishable product 120 (e.g., fish) is placed within a container 200. A different reference number was assigned to the container shown in FIG. 2D as the container 200 in FIG. 2D has electrodes with different height from the bottom surface of the container as compared to the container 100 of FIG. 2C which has electrodes with same height from the bottom surface of the container. In this figure, a fish is not placed flat at the bottom of the container 100 such that the body of the fish contacts both the first electrode E1 and the second electrode E2 at the bottom of the container 100. In particular, due to the curvature and the shape of the fish, in portion A1, the fish and the first electrode E1 are spaced apart by a distance D1 and the fish does not make a direct contact with the first electrode E1. However, due to the first electrode E1 extending upwards having a height H1 greater than a height H2 of the second electrode E2, the fish and the first electrode E1 makes direct contact at portion A2.

The body of the fish closer to the tail of the fish contacts the second electrode E2 at the bottom of the container 100 at portion B1. The tail of the fish also contacts the second electrode E2 at portion B2 even though the height H2 of the second electrode E2 is not as high as H1. As illustrated, the height H1 of the first electrode E1 and the height H2 of the second electrode E2 of the container 100 can have different heights in order to accommodate perishable products 120 that have different sizes, shapes, curvature, length, and thickness to ensure that the perishable product 120 placed within the container 100 contacts the electrodes E1, E2.

FIG. 2E is a top view of a supercooling container according to another embodiment of the present disclosure.

In FIG. 2E, a supercooling container 300 that is different from the supercooling container 100 of FIG. 2A is shown. Here in FIG. 2E, circular shaped electrodes CE1 to CE15 are arranged at the bottom of the container 200. Unlike the container 100 of FIG. 2A, the circular shaped electrodes CE1 to CE15 are spaced apart from each other at the bottom of the container 200. Each of the circular shaped electrodes CE1 to CE15 are electrically isolated or insulated from each other by an insulation member 210. In some embodiments, the insulation member 210 may be identical to the insulation member 110.

While FIG. 2E illustrates a circular shape for the electrodes, the embodiments of the present disclosure are not limited to the circular shape and any shape and size of electrodes with various dimensions can be used that are configured to ensure the contact of the perishable product with at least a pair of electrodes among the plurality of electrodes (e.g., a first circular shaped electrode CE1, a second circular shaped electrode CE2, a third circular shaped electrode CE3, a fourth circular shaped electrode CE4, a fifth circular shaped electrode CE5, a sixth circular shaped electrode CE6, a seventh circular shaped electrode CE7, an eighth circular shaped electrode CE8, a ninth circular shaped electrode CE9, a tenth circular shaped electrode CE10, an eleventh circular shaped electrode CE11, a twelfth circular shaped electrode CE12, a thirteenth circular shaped electrode CE13, a fourteenth circular shaped electrode CE14, and a fifteenth circular shaped electrode CE15).

That is, the electrodes can have a polygonal shape, a bar shape, a strip shape, a coil shape, a wave shape, a zigzag shape, a triangular wave shape, or the like.

FIG. 2F illustrates electrodes having a bar shape. FIG. 2G illustrates electrodes having a curly coil shape. FIG. 2H illustrates electrodes having a cylindrical shape with varying heights.

Referring to FIG. 2E, a perishable product 120, for example, a piece of meat 120 is placed diagonally at the bottom of the container 200. The meat 120 fully contacts or at least partially contacts some of the electrodes. The electrodes that fully contact or at least partially contact the meat 120 include CE2, CE3, CE5, CE6, CE8, CE9, CE10, CE11, CE13, and CE14. On the other hand, electrodes CE1, CE4, CE7, CE14, and CE15 do not contact or overlap with the meat 120.

Each of the electrodes in the supercooling container is coupled to a power source. The power source supplies power to the electrodes so that a pulsed electric field can be applied to the perishable product 120 contacting the electrodes.

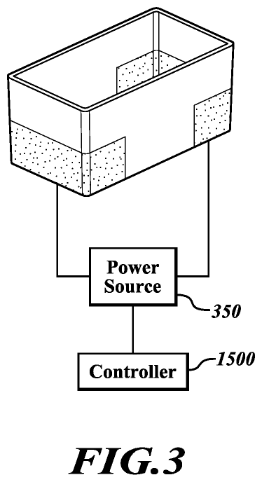

A processor(s) (e.g., controller 1500 in FIG. 3 or FIG. 6) coupled to the container 200 determines, among others, the impedance value between a pair of electrodes of the plurality of electrodes that are contacting the meat 120. Based on the number of electrodes that the meat 120 is contacting, several combinations can be possible. For instance, since there are 10 electrodes (e.g., CE2, CE3, CE5, CE6, CE8, CE9, CE10, CE11, CE13, and CE14) that are contacting the meat, there can be ₁₀C₂ number of combinations which is 45 combinations.

After a number of combinations is determined, the processor sequentially or concurrently determines the impedance value of each pair of electrodes based on the obtained measurement data. The measurement data can be obtained by using any suitable device configured to apply power to the pair of electrodes and measure the impedance value of those selected pair of electrodes. The processor determines which pair of electrodes have the highest impedance value based on the obtained measurement data. The measurement data, which includes impedance values of the perishable products, assists in the selection of the most suitable combination of electrodes for optimal supercooling.

Impedance value is dependent on at least two factors: length and area. Accordingly, impedance value will be the greatest between the pair of electrodes CE3 and CE13.

After the processor determines that CE3 and CE13 is the pair that has the highest impedance value, the processor deactivates the rest of the electrodes CE1, CE2, CE4 to CE12, CE14, and CE15 and only activates electrodes CE3 and CE13 to apply the pulsed electric field through the meat 120.

The pulsed electric field through the meat 120 ensures that meat 120 is not frozen even under freezing temperatures. In some embodiments, other methods such as applying magnetic field can also be utilized in combination with the pulsed electric field.

To elaborate, each magnetic field, electric field, or displacement current may be associated with parameters such as, but not limited to, strength (e.g., magnetic flux density), amplitudes, power level, type of waveforms (e.g., sine wave, square wave, exponential decay, or jagged, or stair stepped, etc.), frequencies, carrier frequency, vector, duty cycles, phase information, etc. The combination of applying at least one of magnetic fields, electric fields, or displacement current drives the electronics which prevent, for example, water molecules from acting as an ice nucleation site inside the perishable product. That is, the external electric field and magnetic field affects the onset of ice crystal formation during freezing and supercooling processes because water consists of dipole molecules and is also diamagnetic. Accordingly, the water molecules that are naturally present in the perishable product tend to realign and re-orientate under electric and magnetic fields, which makes it possible to prevent the ice crystallization process by applying at least one of the appropriate pulsed electric field or oscillating magnetic field or both. This inventive process can also be referred to as the supercooling process to indicate a supercooling state that does not freeze food even below a freezing temperature.

In the embodiment shown in FIG. 2E, the first circular shaped electrode CE1 has a top surface TS and the insulation member 210 has a top surface 210TS. In one embodiment, the top surface TS of the first circular shaped electrode CE1 and the top surface 210TS of the insulation member 210 may be coplanar with each other. The same may apply to the rest of the circular shaped electrodes CE2 to CE15. That is, the top surface of these electrodes CE2 to CE15 may also be coplanar with the top surface of the insulation member 210. However, as well be explained in connection with FIG. 2D, in other embodiments, a top surface of the electrodes may not be coplanar with a top surface of the insulation member.

FIG. 2F is a top view of a supercooling container according to another embodiment of the present disclosure.

In FIG. 2F, a supercooling container 400 that is different from the supercooling container 300 of FIG. 2E only in that the shape of the electrodes are different. As shown, the bar shaped electrodes BE1 to BE6 are arranged at the bottom of the container 400. The bar shaped electrodes BE1 to BE6 are spaced apart from each other at the bottom of the container 400. Each of the bar shaped electrodes BE1 to BE6 are electrically isolated or insulated from each other by an insulation member 310. In some embodiments, the insulation member 210 may be identical to the insulation member 110.

Referring to FIG. 2F, a perishable product 120, for example, a fish 120 is placed at the bottom of the container 300 in a length direction of the container 400. The fish 120 at least partially contacts some of the electrodes. The various shapes of the electrodes assist in ensuring contact with various types of perishable products having various shapes. The electrodes that at least partially contact the fish 120 include BE2, BE3, BE4, and BE5. On the other hand, electrodes BE1 and BE6 do not contact or overlap with the fish 120 from a plan view.

Similar operation is performed by the processor that is operatively coupled to the container 300. That is, the processor determines which pair of electrodes among the plurality of electrodes BE2, BE3, BE4, and BE5 have the highest impedance value. Since there are 4 electrodes that are contacting the fish 120, there are 6 pair of electrodes (4C2), namely a first pair include electrodes BE2 and BE3, a second pair include electrodes BE2 and BE4, a third pair include electrodes BE2 and BE5, a fourth pair include electrodes BE3 and BE4, a fifth pair include electrodes BE3 and BE5, and a sixth pair include electrodes BE4 and BE5. After the measurement data including the impedance values are obtained, the processor determines that the impedance value that is calculated based on the second bar electrode BE2 and the fifth bar electrode BE5 is the largest. Once the pair of electrodes that outputs the largest impedance value is identified and determined, the processor deactivates BE1, BE3, BE4, and BE6 and only activates BE2 and BE5.

After the second bar electrode BE2 and the fifth bar electrode BE5 are activated, the pulsed electric field is applied to the fish 120 so that the supercooling process or the supercooling function is achieved.

FIG. 2G is a top view of a supercooling container according to another embodiment of the present disclosure.

FIG. 2G illustrates that the electrodes may have various shapes including curly or wavy coil shape. As shown, some of the electrodes may have a C shape or an S shape or a U shape. A supercooling container 500 shown in FIG. 2G only differs from the supercooling container 300 shown in FIG. 2A and the supercooling container 400 shown in FIG. 2F in that the electrodes located at the bottom of the container 500 have a different shape. Accordingly, redundant explanation will be omitted here.

Referring to FIG. 2G, some of the electrodes may have an S shape electrode (e.g., 405, 415). The S shaped electrodes may have varying thickness. That is, the S shape electrode 405 has a greater thickness than the S shape electrode 415.

Some of the electrodes may have a C shape electrode (e.g., 425, 445) and a U shape electrode (e.g., 435, 455). Similar to the S shape electrodes, the C and U-shaped electrodes may also have varying thickness. That is, the C shape electrode 425 has a greater thickness than the C shape electrode 445 and the U shape electrode 435 has a greater thickness than the U shape electrode 455. Further, the U shape electrode 455 can be rotated in any direction.

Various embodiments of the present disclosure are provided in order to accommodate the various shapes of the perishable products and taking into account the various random directions in which the product may be lain down at the bottom of the container 400, different shape of electrodes with various dimensions can be utilized.

FIG. 2H is a view showing cylindrical shaped electrodes with varying heights at the bottom of a supercooling container.

FIG. 21 is a side view showing cylindrical shaped electrodes with varying heights at the bottom of a supercooling container.

In FIG. 2H and FIG. 2I, various cylindrical shaped electrodes with various heights are disposed at the bottom of the supercooling container 600. While the embodiments in FIGS. 2A through FIG. 2G were directed to embodiments that have a top surface of the electrodes that are coplanar with a top surface of the insulation member, FIG. 2H and FIG. 21 illustrate an embodiment where a top surface of some of the electrodes are not coplanar with the top surface of the insulation member.

In particular, a first cylindrical shaped electrode C1 has a height L1 and a top surface TSC1. a second cylindrical shaped electrode C2 has a height L2 and a top surface TSC2, and a third cylindrical shaped electrode C3 has a height L3 and a top surface TSC3. The plurality of cylindrical shaped electrodes is spaced apart from each other and electrically isolated from each other through an insulation member 510. The insulation member 510 has a top surface 510TS.

Here, the first cylindrical shaped electrode C1 may have a height L1 that is different from the height L2 of the second cylindrical shaped electrode C2. In FIG. 2H, height L1 is greater than height L2. The height of an electrode may be defined by a distance between the top surface of the electrode and the top surface of the insulation member.

The third cylindrical shaped electrode C3 is referred to as a cylindrical shape but the height L3 of the third cylindrical shaped electrode C3 is zero. That is, the third cylindrical shaped electrode C3 may be considered as a circular shaped electrode where the top surface TSC3 of the electrode C3 is coplanar with the top surface 510TS of the insulation member 510.

However, the top surface 510TS of the insulation member 510 may not be coplanar with the top surface TSC1 of the first cylindrical shaped electrode C1 and the top surface TSC2 of the second cylindrical shaped electrode C2.

FIG. 2J is a view showing cylindrical shaped electrodes can have adjusted heights by controlling the height of the electrode at the bottom of a supercooling container.

FIG. 2J shows an example cylindrical shaped electrode CX among a plurality of cylindrical shaped electrodes that can dynamically adjust the height of the electrode to ensure contact of the various types and shapes of perishable products placed in the supercooling container 700. The rest of the cylindrical shaped electrodes are omitted from the drawings for brevity and to avoid repetition.

In one embodiment, the cylindrical shaped electrode CX may be coupled to a height adjusting mechanism 630. The height adjusting mechanism 630 is positioned underneath the cylindrical shaped electrode CX to adjust the height of each electrode CX to ensure that the electrodes contact the perishable product. The height adjusting mechanism 630 can include an electric motor. The motor is coupled to all of the plurality of cylindrical shaped electrodes and is configured to adjust the height of each electrode upon receiving instructions signal from the processor. The motor may be located at a height adjusting mechanism layer ML that is beneath the cylindrical shaped electrode CX. A space layer SL may be located between the cylindrical shaped electrode CX and the height adjusting layer ML. The space layer SL includes one or more spaces 640 so that when the processor controls the height adjusting mechanism 630 to lower the height of the cylindrical shaped electrode CX, the portion of the electrode CX goes beneath a top surface 610TS of an insulation member 610 and into the space 640. Similarly, as other insulation members mentioned throughout the disclosure, the insulation member 610 electrically insulates the plurality of cylindrical shaped electrodes from each other.

In one embodiment, the height of the cylindrical shaped electrode CX may be adjusted such that a top surface TSCX of the electrode CX is coplanar with the top surface 610TS of an insulation member 610.

In some embodiments, the cylindrical shaped electrode CX may have a height and a radius such that it has a shape close to a needle or a slim and lean cylinder. In order to ensure contact, in some embodiments, the height adjusting mechanism 630 can push up the cylinder-shaped electrode and push it towards the meat or fish so that it at least partially extends into the meat or fish.

FIG. 3 is a view showing the connections of the power source to the electrodes according to various embodiments of the present disclosure.

As shown, a power source 350 is electrically connected to the electrodes of the supercooling container 300 shown in FIG. 2E.

A controller 1500, as used herein, broadly includes any processor-based or microprocessor-based system including systems using microcontrollers, integrated circuit, chip, microchip, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “controller.”

In some embodiments, the controller 1500 described herein may be included in or otherwise implemented by processing circuitry such as a microprocessor, microcontroller, or the like.

The controller 1500 is operatively coupled to the power source 350 such that the controller 1500 controls which combination of electrodes are provided with power. Referring to FIG. 2E, the controller 1500 supplies power to the various pairs of electrodes subsequently or concurrently and obtains measurement data that shows the highest impedance value among the various pairs of electrodes. In FIG. 2E, the pair of electrodes including CE3 and CE13 has the longest longitudinal path and therefore has the highest impedance value. Once the pair of electrodes with the highest impedance value is identified, the controller 1500 controls the power source 350 to activate electrodes CE3 and CE13 while deactivating the rest of the electrodes and supplies the pulsed electric field to the perishable product 120.

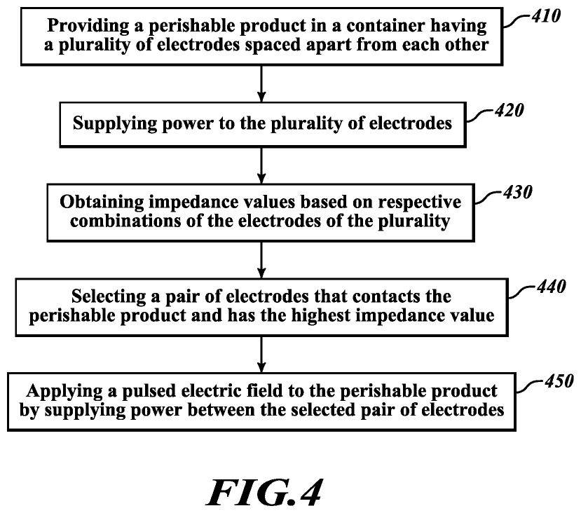

The details of the operation of the controller 1500 will be further detailed in FIG. 4.

FIG. 4 is a flow chart of an example method according to some embodiments of the present disclosure.

In step 410, a perishable product 120 is provided in a supercooling container 20 having a plurality of electrodes spaced apart from each other. Here, the perishable product 120 contacts at least two electrodes of the plurality.

In step 420, the controller 1500 controls a power source 350 so that power is supplied to the plurality of electrodes.

In step 430, the controller 1500 obtains impedance values based on respective combinations of the electrodes of the plurality. That is, the controller 1500 obtains the impedance value between the various pair of electrodes of the plurality of electrodes that are contacting the perishable product 120.

In step 440, the controller 1500 selects a pair of electrodes that contacts the perishable product and has the highest impedance value.

In step 450, the controller 1500 controls the power source so that a pulsed electric field is applied to the perishable product 120.

To elaborate with reference to steps 430, 440, 450, the controller 1500 first determines the number of combinations. Based on the number of combinations, power is provided by the power source to each combination. At this point, the measurement data including information on impedance value is obtained and provided to the controller 1500. Then the controller 1500 determines which pair of electrodes have the highest impedance value based on the obtained measurement data (step 440). Once the controller 1500 determines that the impedance value is the greatest between the pair of electrodes CE3 and CE13, the controller 1500 controls the power source to power the pair of electrodes CE3 and CE13. Accordingly, the pulsed electric field is applied to the perishable product 120 through electrodes CE3 and CE13 (step 450).

According to some embodiments, supplying power to the plurality of electrodes in step 420 includes the controller 1500 determining whether there is contact between electrodes of the plurality and the perishable product.

The determination of whether there is contact between the perishable product and the electrodes can be also accomplished by using various sensors. For instance, a weight sensor that is coupled to or incorporated with the electrodes can be used. That is, based on FIG. 2E, if the weight sensors are placed in a location corresponding to each electrode shown in FIG. 2E, a weight of the perishable product 120 may be sensed where the perishable product 120 is placed. For instance, the weight sensor located at electrode CE1 will not have any weight information as the perishable product 120 does not overlap with electrode CE1. Electrodes CE3 and CE5, on the other hand, will have weight information as the perishable product 120 does overlap with electrodes CE3 and CE5. The controller 1500 can determine based on the measurement information (e.g., weight) which electrodes overlap with the perishable product 120. Further, once these electrodes are identified, the controller 1500 may activate only those electrodes that overlap with the perishable product 120.

Another way to sense the contact between the perishable product and the electrodes can be also accomplished by using distance sensors (e.g., range sensors, time of flight sensors, or the like). For instance, a time of flight sensor can be coupled to or incorporated with the electrodes. Here, if the time of flight sensors are placed in a location corresponding to each electrode shown in FIG. 2E, a distance information between the time of flight sensor and the perishable product 120 may be sensed. For instance, the time of flight sensor located at electrode CE1 will return a first distance measurement as the perishable product 120 does not overlap with electrode CE1. The time of flight sensor located at electrode CE5 will also return a second distance measurement as the perishable product 120 does overlap with electrode CE5. Here, the first distance measurement is greater than the second distance measurement. Similarly, all of the electrodes that at least partially overlap or fully overlap with the perishable product 120 may return a same or similar value as the second distance measurement. The controller 1500 can determine based on the measurement information (e.g., distance) which electrodes overlap with the perishable product 120. Further, once these electrodes are identified, the controller 1500 may activate only those electrodes that overlap with the perishable product 120.

Other sensors such as image sensors, temperature sensors can also be used to identify the overlap of the electrodes with the perishable product.

Further, various combinations of the sensors can be used to identify the overlap of the electrodes with the perishable product.

However, as mentioned earlier, the process of identifying electrodes that overlap with the perishable product and the process of determining electrode pairs with the highest impedance value may be obtained by applying power source to various combination of the electrodes and collecting impedance value measurements.

According to some embodiments, obtaining impedance values based on respective combinations of the electrodes in step 430 includes the controller 1500 obtaining an impedance value between electrodes that are positioned the greatest distance from each other among the electrodes that contact with the perishable product.

In one embodiment, the controller 1500 may apply power to electrodes that have the greatest distance from each other among the electrodes that contact with the perishable product 120. Referring to FIG. 2E, electrodes CE3 and CE13 have the greatest distance from each other among the electrodes CE2, CE3, CE5, CE6, CE8, CE9, CE10, CE11, CE13, and CE14 that are in contact with the perishable product 120.

Generally, the impedance value is likely to be highest for the longest longitudinal path within the perishable product. Accordingly, in order to reduce the calculation that the controller 1500 performs, the controller 1500 may control the power source 350 to supply power to those electrodes that are spaced apart the farthest.

According to some embodiments, obtaining impedance values based on respective combinations of the electrodes in step 430 includes the controller 1500 obtaining measurement data between electrodes that are positioned the second greatest distance from each other among the electrodes that contact with the perishable product.

In some embodiments, the controller 1500 may perform a selection criterion for the optimal electrode combination. For instance, the controller 1500 may supply power to those electrodes that have the greatest distance from each other and then subsequently supply power to those electrodes that have the second greatest distance from each other.

In some instances, supplying power to those electrodes that have the greatest distance from each other may return a first impedance value. Similarly, supplying power to those electrodes that have the second greatest distance from each other may return a second impedance value. The controller 1500 may do a comparison of these two impedance values and if the first impedance value is greater than the second impedance value, the controller 1500 can stop the process of obtaining impedance value for all combinations of electrode pairs that contact the perishable product.

On the other hand, if the controller 1500 performs a comparison of these two impedance values and if the first impedance value is smaller than the second impedance value, the controller 1500 further obtains measurement data between electrodes that are positioned the third greatest distance from each other among the electrodes that contact with the perishable product. The impedance value of the third greatest distance from each other among the electrodes that contact with the perishable product may be a third impedance value.

If the controller 1500 performs a comparison of these two impedance values (e.g., second impedance value and the third impedance value) and the second impedance value is greater than the third impedance value, the controller 1500 can stop the process of obtaining impedance value for the rest of the combinations of electrode pairs that contact the perishable product.

Similarly, if the second impedance value is smaller than the third impedance value, then the controller 1500 may continue to control the power source to supply power to the electrodes of the plurality that contact the perishable product, and continue to obtain the impedance value of the electrodes until the electrodes that are nearest each other are measured.

This process can limit the number of power sources applied to the combinations of electrode pairs and can save the controller's processing resources and operation time, can also save power consumption of the power source.

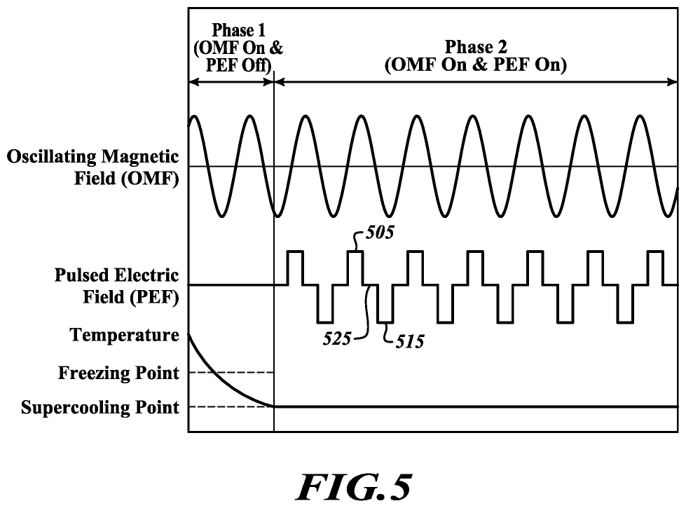

FIG. 5 illustrates a stepwise control of pulsed electric field and oscillating magnetic field during supercooling according to some embodiments of the present disclosure.

In some embodiments, the method of supercooling a perishable product, such as a food product, comprises cooling the perishable product to a temperature below its freezing point while applying a pulsed electric field and oscillating magnetic field to the perishable product. The pulsed electric field and oscillating magnetic field are maintained while the product is stored in the supercooled state in the apparatus 10. In some embodiments, the product does not freeze in the supercooled state. In some embodiments, the perishable product is a product that contains water.

In some embodiments, the perishable product is first cooled while applying an oscillating magnetic field. In some embodiments, the pulsed electric field is not applied at this time depending on the type of perishable product. For example, the product can be supercooled by being placed in the apparatus 10, while an oscillating magnetic field is applied. Once the product has reached a supercool temperature or supercooling point (e.g., the supercool temperature may range between 0° Celsius and −80° Celsius depending on the perishable product), the pulsed electric field is added and the combination of the pulsed electric field and oscillating magnetic field is maintained for as long as the product is to be stored at a supercooled temperature.

Referring to FIG. 5, during a first phase PHASE 1, the oscillating magnetic field is on and the pulsed electric field is off. During a second phase PHASE 2, both the oscillating magnetic field and the pulsed electric field are provided. In some embodiments, the perishable product is cooled while applying the oscillating magnetic field and the pulsed electric field is added when the temperature has stabilized. In some embodiments, the perishable product is cooled while applying the oscillating magnetic field and the pulsed electric field is added when a desired temperature has in been reached. For example, the pulsed electric field may be added when a temperature at which the perishable product is to be stored has been reached. In some embodiments, the temperature may be between about −1° C. and about −20° C., for example about −7° C. or about −8° C. In some embodiments, the product is cooled while applying both the oscillating magnetic field and the pulsed electric field, and both are maintained during storage.

An oscillating magnetic field (OMF) generator comprising solenoid coils can create an oscillating magnetic field with a defined intensity as measured in the container 20 of the supercooling apparatus 10.

In some embodiments, the method of supercooling a perishable product comprises cooling the perishable product to a temperature below its freezing point while only applying a pulsed electric field to the perishable product. That is, in other words, the oscillating magnetic field may not be applied at all during PHASE 1 and PHASE 2. The pulsed electric field is maintained while the perishable product is stored in the supercooled state in the apparatus 10. In some embodiments, the product does not freeze in the supercooled state.

In some embodiments, the perishable product is first cooled to a freezing point while applying the pulsed electric field. In some embodiments, the perishable product is first cooled to a freezing point and then the pulsed electric field is applied. Once the product has reached a supercool temperature or supercooling point, the pulsed electric field is maintained for as long as the product is to be stored at a supercooled temperature.

As shown in FIG. 5, the PEF waveform has two pulses that are each biphasic wherein each cycle is comprised of one polarity phase 505 followed by an opposite polarity phase 515. There is also a delay 525 between one polarity phase 505 and an opposite polarity phase 515.

In some embodiments, the PEF waveform may have two pulses that are of the same polarity. That is, each cycle may be comprised of one polarity phase followed by the same polarity phase. Further, the shape of the PEF waveforms can be of various shapes and is not necessarily limited to a square shape waveform. In addition, the delay 525 between one polarity phase and the same polarity phase can be adjusted depending on the perishable product.

FIG. 6 is an example system diagram of a supercooling system including a supercooling container shown in FIG. 1.

A supercooling system 1100 according to the present disclosure includes a supercooling container 20, a pulsed electric field (PEF) system 1300, an oscillating magnetic field (OMF) system 1400, a controller 1500, a memory 1600, a measurement system 1700, and a temperature controller 1800. The components of the system 1100 are not exhaustive and other components necessary to operate the supercooling method as described in this present disclosure may be included.

The supercooling container 20 described in FIG. 6 may not be identical but similar to the supercooling container explained in conjunction with FIGS. 1 and 2.

The PEF system 1300 is operatively coupled to the various electrodes of the supercooling container 20 to create pulsed electric fields through rapid discharge of electrical energy within a finite period of time. As explained previously, such pulses follow a pattern known as a waveform, which represents how an electrical current varies over time. Common waveforms for electrical currents include the square wave, the sine wave, the ramp, the sawtooth wave, and the triangular wave. However, these are mere examples, and the waveforms can have various shapes. In a squared waveform, the amplitude of the wave alternates at a steady frequency between fixed minimum and maximum values, with the same duration at minimum and maximum. As described elsewhere, in some embodiments, a squared waveform is used in applying a PEF to a perishable product. In addition to having a waveform, the pulsed electric fields can follow a duty cycle.

The PEF system 1300 includes a function generator 1310 and a power supply 1320. Power supplies used for generating the pulsed electric fields are well known in the art and are commercially available. The power supply 1320 can be a capacitor charging power supply with frequency alternating current (AC). A non-limiting example of a suitable power supply is an integrated-gate-bipolar-transistor based power supply (IGBT).

Electrodes coupled to the power supply are placed such that they are directly or indirectly in contact with the perishable material when it is placed in the supercooling container 20. In some embodiments, direct contact may be preferred in that it may require higher frequency and higher power to pass through air and pass the displacement current through the perishable product if the perishable product does not directly contact the electrodes. Suitable electrode materials include, but are not limited to stainless steel, titanium, gold, and silver. The electrodes can be formed in a variety of shapes, including but not limited to plates, prongs, and conductive films. In one embodiment, the electrodes can further be designed with multiple holes to enhance the circulation of cold air. Depending, for example, on the type of food or other perishable material, different types of electrodes can be selected, such as the side electrodes or the bottom electrodes or the top electrodes.

The power supply can provide an input voltage. A suitable, non-limiting peak-to-peak voltage setting is about 5 V. Suitable, non-limiting electrical currents provided by the power supply can be up to about 0.04 A. The current produced by the power supply can also be characterized by a working frequency. A suitable, non-limiting example of a frequency for the pulsed electric fields applied to supercooling is less than 50 kHz.

The pulsed electric fields can be controlled using function generators 1310. Suitable function generators are commercially available and well-known in the art. Function generators control square wave forms with various duty cycles and working frequencies.

The OMF system 1400 is operatively coupled to the supercooling container 20 to apply an oscillating magnetic field to a perishable material as described herein. The oscillating magnetic field may be generated, for example, by using one or more electromagnets or by a combination of an electromagnet with a permanent magnet.

Examples of suitable systems for producing an oscillating magnetic field include, but are not limited to, one electromagnet located to one side of the perishable material, two electromagnets located on opposite sides of a perishable material, or an electromagnet and a permanent magnet located on opposite sides of a perishable material. In some embodiments, more than one set of electromagnets may be utilized. For example, in some embodiments, four electromagnets are located at each side of the container holding the perishable material.

In other embodiments, in order to provide an oscillating magnetic field within the supercooling container 20, a solenoid configuration may be used.

Like the pulsed electric field, a pulsed magnetic field can be generated with a function generator 1410 and power supply 1420 to the electromagnet. Suitable power supplies are commercially available, and may be, for example, an IGBT as described above. The oscillating magnetic field is regulated via the function generator 1410 through an input voltage, which can range from 50 to 150 V at a frequency of 1-20 Hz.

A suitable, non-limiting example of an oscillating magnetic field is a pulse type field with an intensity ranging from −150 mT to 150 mT. Another non-limiting example includes a combined magnetic flux density by permanent magnet and electromagnet oscillated between 50 to 500 mT per second.

An oscillating magnetic field (OMF) generator comprising solenoid coils can create an oscillating magnetic field with a defined intensity as measured in the container of the supercooling apparatus.

The supercooling system 1100 includes a controller 1500 (or controllers 1500) to control the PEF generator, OMF generator, and other components operatively coupled to the controller 1500. In some embodiments, the controller 1500 is set to deliver an applied PEF as a squared waveform, as described herein. An example of an applied PEF delivered as a squared waveform at high frequency (20 Hz) with a programmed duty cycle is shown in FIG. 5. In this non-limiting example, the cooling decays from an initial food temperature to a supercooling temperature during Phase 1 with oscillating magnetic field (OMF) on and PEF off. In Phase 2 (immediately after supercooling is reached), both OMF and PEF applied with programmed duty cycles are used to maintain the supercooling temperature of the perishable product.

The controller 1500 may perform the various functions and methods of performing supercooling as described herein. The controller 1500 may include any processor-based or microprocessor-based system including systems using microcontrollers, integrated circuit, chip, microchip, reduced instruction set computers (RISC), application specific integrated circuits (ASICs), field-programmable gate arrays (FPGAs), graphical processing units (GPUs), logic circuits, and any other circuit or processor capable of executing the various operations and functions described herein.

In some embodiments, the controller 1500 may be operatively coupled to an artificial intelligence image processing circuitry so that some part of an image analysis performed by the controller 1500 can utilize the artificial intelligence image processing circuitry that is trained to determine which electrodes of the container overlap with the perishable products in order to accurately detect and select which electrodes to activate and deactivate.

In one or more embodiments, the controller 1500 may be operatively coupled to the supercooling container but is not limited to being directly and physically coupled to the container. For instance, the container may be communicatively coupled to the controller 1500 such that wireless data exchange is established using various wireless communication technologies. That is, the analysis by the controller 1500 may be performed elsewhere that is away from the actual supercooling container. For instance, sensor measurements or sensed data may be uploaded using any type of suitable wireless communication schemes such as Wi-Fi, Bluetooth, Internet, or other means, in order to perform the data analysis entirely remotely or partially remotely. The optimized control instructions (including parameter setting information such as amplitude, magnitude, frequency, phase relationship, waveforms, duty cycles, direction of which electric field is applied, direction of which magnetic field is applied, or the like) can be returned to the supercooling apparatus 10 by the same communication means and have the optimized control instructions executed. These optimized control instructions may cause the electric field function generator 1310 or the magnetic field function generator 1410 or both to generate the suitable electric field and magnetic field based on the different type of perishable products within the supercooling container 20.

The supercooling system 1100 includes a memory 1600. The memory 1600 is operatively coupled to the controller 1500 so that the controller 1500 can retrieve various information including the measurement information stored in the memory. The memory may include Random Access Memory (RAM) and Read Only Memory (ROM). The memory may be in a form of a storage device, which may be a hard disk drive or a removable storage drive such as an optical disk drive, solid state disk drive (e.g., flash ROM), and the like. The storage device may also be other similar means for loading computer programs or other instructions into the computer or processor.

The supercooling system 1100 includes a measurement system 1700. The measurement system may use the various sensors coupled to the supercooling container 1200 to obtain measurement data and transmit to the controller 1500 for analysis. The non-limiting examples of sensors include image sensors, weight sensors, distance sensors (e.g., range sensors, time of flight sensors, or the like), quantity sensors, or the like.

The supercooling system 1100 includes a temperature controller 1800 which controls the temperature of the supercooling container 20.

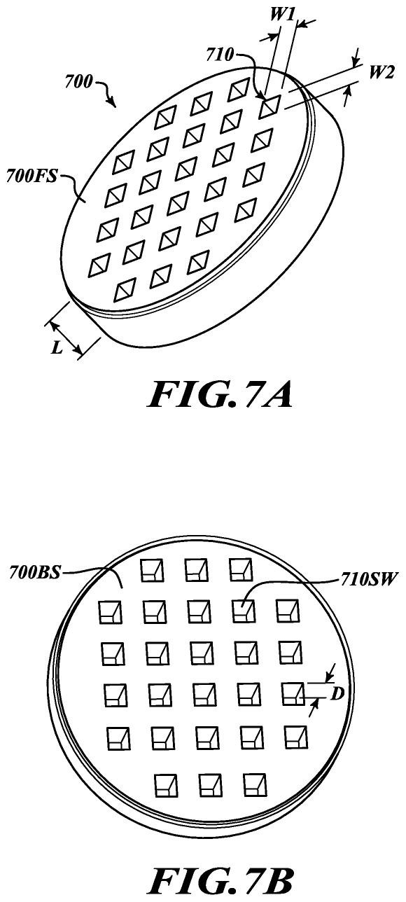

FIG. 7A is a perspective view of an example electrode having a plurality of pores according to some embodiments of the present disclosure.

Here, a single electrode 700 with a plurality of pores 710 is shown. The number of pores and the specific arrangement of pores may vary and is not necessarily limited to the example shown in FIG. 7A. The electrode 700 includes a front surface 700FS and the plurality of pores 710 is formed at the front surface 700FS of the electrode 700. As shown in FIG. 7B, the electrode 700 also includes a back surface 700BS and each pore may extend from the front surface 700FS to the back surface 700BS of the electrode 700.

During operation of the supercooling container, there may be occasional dehydration at the perishable product/electrode interface. This is caused partially due to some combination of being exposed to the cold air and being locally heated. In some embodiments, the surface of the electrode may have a plurality of pores instead of a solid continuous surface. For instance, the electrodes that have a mesh-shape with some open spaces and some depth may be provided. This arrangement and design of the electrode may allow some of the perishable product's moisture to collect in those spaces on the electrode surface, providing some localized moisture sources.

The various electrodes with different shapes and designs described in connection with FIGS. 2A to 2J. The electrode as shown in FIG. 7A may be applied to the electrodes shown in the previous figures.

Each pore shown in FIG. 7A has a square shape with a width W1 in a first direction and a width W2 in a second direction transverse to the first direction. In some embodiments, the width W1 in the first direction and the width W2 in the second direction may be the same to form a square-shaped pore. In some embodiments, the width W1 in the first direction and the width W2 in the second direction may be different from each other and the angle therebetween may be different to form a non-square-shaped (e.g., rectangle, rhombus, diamond, trapezoid, or the like) pore.

FIG. 7B is a bottom perspective view of the electrode having a plurality of pores as shown in FIG. 7A. As shown, each pore may have a depth D. In some embodiments, the pore may extend through the electrode and therefore have a depth D that is equal to a thickness or height L of the electrode.

As shown, each pore has a sidewall 710SW. The sidewall 710SW of the electrode may have a height that is equal to the depth D of the pore. This value may also be equal to the height L of the electrode 700.

In other embodiments, the pores may have a circular shape instead of a square shape shown in FIGS. 7A and 7B. The shapes of the pores are not limited to a circular shape or a square shape and any other shape that is suitable for performing the function of the pores within an electrode may be utilized.

In one embodiment, the method comprises supplying power to various combinations of electrodes within the container, obtaining measurement data for each combination, and selecting the combination based on the obtained measurement data. The selected combination of electrodes is then used to apply a pulsed electric field to the perishable products in contact with the electrodes, thereby achieving supercooling.

Optionally, the method includes maintaining the temperature of the perishable products within a selected temperature range during the application of the pulsed electric field. In some embodiments, an oscillating magnetic field may be simultaneously applied to enhance the supercooling process.

The selection of the electrode combination is based on impedance values obtained from the measurement data. The electrodes that output the highest impedance value for the perishable products are selected for the pulsed electric field application.

Additionally, the method involves determining whether there is an overlap between the electrodes and the perishable products. These can be determined by using various sensors such as image sensors, weight sensors, distance sensors. The various sensors can be used in combination to produce an accurate determination on which electrodes contact the perishable products. After the determination of which combination of electrodes contact the perishable products, the various combinations of electrodes that overlap with the products are considered for power supply and measurement. In one embodiment, the measurement data is obtained between electrodes positioned at the greatest distance from each other among those overlapping electrodes.

In another embodiment, a supercooling container system is provided. The container comprises a bottom surface, one or more side surfaces, and a plurality of electrodes located in various positions within the container. The selected pair of electrodes, among the plurality, is configured to pass current through the perishable products in contact with them.

The electrodes can be disposed on the bottom surface, the side surfaces, the top surfaces, or a combination thereof. They may have circular or polygonal shapes, allowing for flexible arrangements to accommodate different container sizes and product volumes. That is, the arrangement and positioning of electrodes within the container may vary based on the different embodiments.

The method and system described herein offer several advantages over existing solutions. By selectively applying pulsed electric fields using a plurality of electrodes, precise and efficient supercooling of perishable products is achieved. The ability to choose electrode combinations based on impedance values ensures optimal supercooling performance. Furthermore, the system can be adapted to containers of various sizes, enhancing its versatility.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
for each combination of a plurality of combinations of electrodes:
supplying power to the combination of electrodes, the electrodes being positioned within a container that houses one or more perishable products; and
obtaining measurement data for the combination of electrodes;
selecting a combination of electrodes from the plurality of combinations of electrodes based on the obtained measurement data; and
applying a pulsed electric field between a first electrode and a second electrode of the selected combination of electrodes so as to apply the pulsed electric field to the one or more perishable products that contact the first electrode and the second electrode.

2. The method of claim 1, comprising:
applying an oscillating magnetic field to the one or more perishable products in the container while concurrently applying the pulsed electric field to the one or more perishable products.

3. The method of claim 1, further comprising maintaining a temperature of the one or more perishable products within a selected temperature range while the pulsed electric field is applied between the first electrode and the second electrode of the selected combination of electrodes.

4. The method of claim 3, wherein the selected temperature range is between 0° Celsius and −80° Celsius.

5. The method of claim 1, wherein the measurement data includes an impedance value of the one or more perishable products.

6. The method of claim 5, wherein selecting a combination of electrodes based on the obtained measurement data includes:
selecting a pair of electrodes that outputs the highest impedance value of the one or more perishable products,
wherein the selected pair of electrodes that outputs the highest impedance value is the first electrode and the second electrode.

7. The method of claim 1, wherein supplying power to a combination of electrodes positioned within a container configured to house one or more perishable products includes:
determining whether there is an overlap between electrodes and the one or more perishable products; and
selecting a combination of electrodes among electrodes that overlap with the one or more perishable products.

8. The method of claim 7, wherein obtaining measurement data for the combination of electrodes includes:
obtaining measurement data between electrodes that are positioned the greatest distance from each other among the electrodes that overlap with the one or more perishable products; and
obtaining measurement data between electrodes that are positioned the second greatest distance from each other among the electrodes that overlap with the one or more perishable products.

9. The method of claim 8, wherein among the combination of electrodes, electrodes that are nearest each other are measured last.

10. A method, comprising:
providing a perishable product in a container having a plurality of electrodes spaced apart from each other, the perishable product contacting at least two electrodes of the plurality;
supplying power to the plurality of electrodes;
obtaining impedance values based on respective combinations of electrodes of the plurality;
selecting a pair of electrodes that contacts the perishable product and has the highest impedance value; and
applying a pulsed electric field to the perishable product by supplying power between the selected pair of electrodes.

11. The method of claim 10, wherein supplying power to the plurality of electrodes includes:
determining whether there is contact between electrodes of the plurality and the perishable product; and
supplying power to the electrodes that are in contact with the perishable product.

12. The method of claim 11, wherein obtaining impedance values based on respective combinations of the electrodes includes:
obtaining an impedance value between electrodes that are positioned the greatest distance from each other among the electrodes that contact with the perishable product; and
obtaining measurement data between electrodes that are positioned the second greatest distance from each other among the electrodes that contact with the perishable product.

13. The method of claim 12, wherein among the electrodes of the plurality, an impedance value of the electrodes that are nearest each other are measured last.

14. A supercooling container, comprising:
a bottom surface;
one or more side surfaces connected to the bottom surface; and
a plurality of electrodes located in various locations within the supercooling container, a selected pair of electrodes of the plurality configured to pass current through a perishable product contacting the selected pair of electrodes, each of the plurality of electrodes being spaced apart from each other.

15. The supercooling container of claim 14, wherein each of the plurality of electrodes is disposed only on the bottom surface.

16. The supercooling container of claim 14, wherein at least one of the plurality of electrodes is disposed at the bottom surface, and at least one of the plurality of electrodes is disposed on at least one of the side surfaces.

17. The supercooling container of claim 14, wherein each of the plurality of electrodes has a circular shape or a polygonal shape.

18. The supercooling container of claim 14, comprising:
a top surface connected to the one or more side surfaces,
wherein at least one electrode of the plurality of electrodes is disposed on the top surface, and at least one electrode of the plurality of electrodes is disposed on the bottom surface.

19. The supercooling container of claim 14, wherein at least one electrode of the plurality of electrodes includes one or more pores at a surface of the at least one electrode.

20. A system, comprising:
a supercooling container including:
a bottom surface;
side surfaces connected to the bottom surface; and
a plurality of electrodes located in various locations within the supercooling container, each of the plurality of electrodes being spaced apart from each other;
a pulsed electric field generator operatively coupled to the plurality of electrodes of the supercooling container, the pulsed electric field generator, in operation, applies pulsed electric field to the plurality of electrodes to pass current through one or more perishable products; and
a controller operatively coupled to the supercooling container, the controller, in operation:
for each combination of a plurality of combinations of electrodes:
supplying power to the combination of electrodes;
obtaining measurement data for the combination of electrodes;
selecting a combination of electrodes from the plurality of combinations of electrodes based on the obtained measurement data; and
applying the pulsed electric field between a first electrode and a second electrode of the selected combination of electrodes so as to apply the pulsed electric field to the one or more perishable products that contact the first electrode and the second electrode.

21. The system of claim 20, comprising a temperature controller operatively coupled to the supercooling container, the temperature controller, in operation, controls a temperature of the one or more perishable products in the supercooling container to a selected temperature range.

22. The system of claim 21, wherein the temperature controller, in operation, maintains a temperature of the one or more perishable products within a selected temperature range while the pulsed electric field is applied between the first electrode and the second electrode of the selected combination of the electrodes.

23. The system of claim 20, wherein the measurement data includes an impedance value of the one or more perishable products.

24. The system of claim 20, wherein selecting a combination of the electrodes based on the obtained measurement data includes:
selecting a pair of electrodes that outputs the highest impedance value of the one or more perishable products,
wherein the selected pair of electrodes that outputs the highest impedance value is the first electrode and the second electrode.

25. The system of claim 20, wherein supplying power to a combination of electrodes includes:
determining whether there is an overlap between electrodes and the one or more perishable products; and
selecting a combination of electrodes among electrodes that overlap with the one or more perishable products.

26. The system of claim 20, wherein obtaining measurement data for the combination of electrodes includes:
obtaining measurement data between electrodes that are positioned the greatest distance from each other among the electrodes that overlap with the one or more perishable products; and
obtaining measurement data between electrodes that are positioned the second greatest distance from each other among the electrodes that overlap with the one or more perishable products.

27. The system of claim 20, wherein among the combination of electrodes, electrodes that are nearest each other are measured last.

28. The system of claim 20, wherein at least one electrode of the plurality of electrodes includes one or more pores at a surface of the at least one electrode.
